(19) United States
(12) Patent Application Publication
(10) Pub. No.: US 2005/0087988 A1
(43) Pub. Date: Apr. 28, 2005

(54) Fuel Free And Self Powered Generator

(76) Inventor: Rodolfo Silvano Mendoza, Midlothian, VA (US)

Correspondence Address: RODOLFO S. MENDOZA, 812 KRIM POINT LOOP, MIDLOTHIAN, VA, 23114, US

(21) Appl. No.: 10/605,806

(22) Filed: Oct. 28, 2003

(51) Int. Cl. H02P 9/04

(52) U.S. Cl. 290/1 R

(57) ABSTRACT

The use of this invention in a large scale can effectively eliminate the use of fuel and stop pollution, in this small scale design, appliances and small tools was able to run successfully.

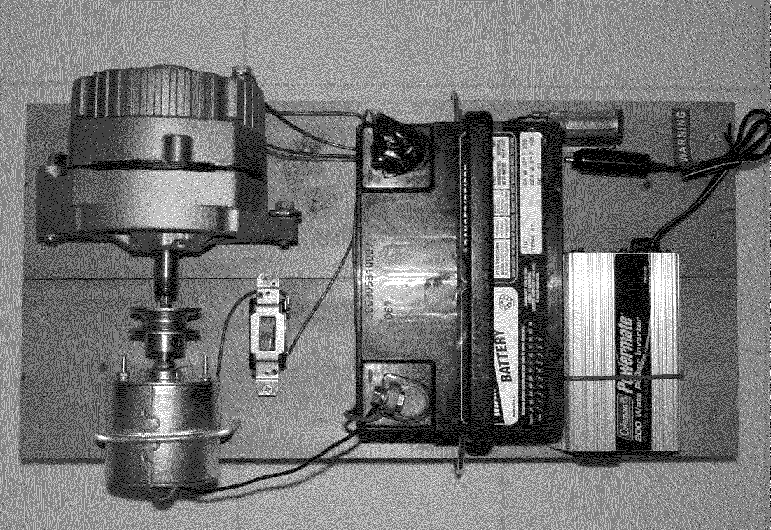

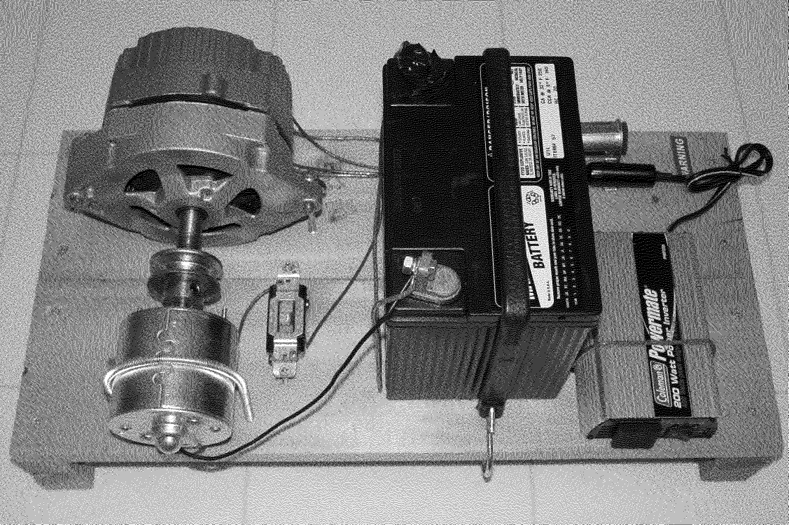

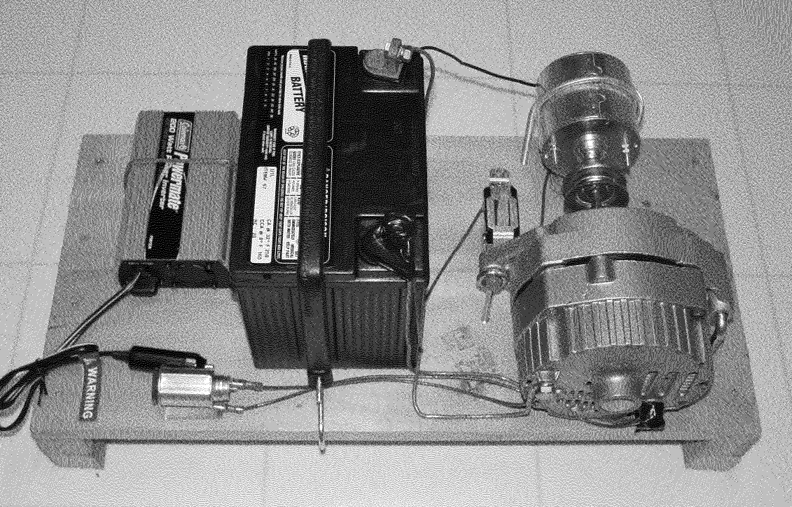

### DETAILED DESCRIPTION

The invention of this generator consists of 12 volts car generator, a 12 volts mowing tractor battery, and a 12 volts DC electric motor. On the board is attached an On/Off switch, a car cigarette lighter, and a power inverter to provide 120 V AC current to run appliances or powered tools.

When the On/Off switch is turned on the 12 volts DC motor, witch is attached directly to the generator, will run the generator to generate electricity. The generator supplies the power to charge the battery, run the motor, and supply the power for the power inverter.

The power provided for the 12 volts DC electric motor, is wired to a negative and positive battery terminal. Between the positive battery terminal and the motor is an On/Off switch. Te generator is wired to the negative and positive battery terminal to maintain a fully charged battery, and the generator also has another negative and positive connection, which runs to the cigarette lighter, that supplies power to the inverter.

1. A method of eliminating the use of fuel on electric cars.

2. A method of eliminating the use of fuel on portable generators.

3. A method of generating constant power by it own electricity.
